(19) United States
(12) Patent Application Publication
(10) Pub. No.: US 2013/0235014 A1
(43) Pub. Date: Sep. 12, 2013

(54) METHOD OF OPERATING DISPLAY DRIVER AND DISPLAY CONTROL SYSTEM

(71) Applicant: SAMSUNG ELECTRONICS CO., LTD., Suwon-Si (KR)

(72) Inventors: Jong-Sung LEE, Seoul (KR); Byung Koan KIM, Suwon-si (KR); Joong Eon LEE, Seongnam-si (KR)

(73) Assignee: SAMSUNG ELECTRONICS CO., LTD., Suwon-Si (KR)

(21) Appl. No.: 13/722,187

(22) Filed: Dec. 20, 2012

(30) Foreign Application Priority Data
Mar. 12, 2012 (KR) 10-2012-0024814

(51) Int. Cl. G06F 1/32

(52) U.S. Cl. CPC G06F 1/32
USPC 345/211

(57) ABSTRACT

A method of operating a display driver and a display control system are provided. The method includes comparing cyclic redundancy checks (CRCs) of each of a plurality of first frame data, which are consecutively received, with each other; comparing a plurality of second frame data, which are consecutively received, with each other when the CRCs of each of the plurality of first frame data are equal to each other; and entering a panel self-refresh mode when the plurality of second frame data are equal to each other.

### CROSS-REFERENCE TO RELATED APPLICATIONS

This application claims priority under 35 U.S.C. §119 to Korean Patent Application No. 10-2012-0024814, filed on Mar. 12, 2012 in the Korean Intellectual Property Office (KIPO), the entire contents of which are incorporated herein by reference.

### BACKGROUND

Embodiments of the inventive concepts relate to a method of operating a display driver, and more particularly, to a method of operating a display driver in a panel self-refresh (PSR) mode when a still image is received from a host, thereby reducing power consumption, and a display control system.

An application processor transmits image data to a display driver at a desired (or, alternatively a predetermined rate). The rate is called a refresh rate or a vertical frequency and is maintained constant even when there is no change in the image data. In other words, even while a still image is being displayed, the application processor transmits the image data to the display driver, consuming power.

A display driver that has recently been developed uses a PSR function to reduce power consumption. When the PSR function is used, the output of image data from the application processor is stopped and the image data stored in memory (e.g., a frame buffer) included in a display controller is displayed when the image data received from a host is a still image.

When a display system operates in a PSR mode, the power consumption of a display module including the display driver and the application processor can be reduced. Therefore, the PSR function may be used in mobile devices that are provided power from a battery with a limited capacity, thereby saving system power and lengthening the lifespan of the battery.

Conventionally, the application processor determines whether image data displayed is a still image and transmits a control signal on PSR to the display driver according to a determination result.

To determine whether the image data is a still image using the application processor, cyclic redundancy check (CRC), frame buffer address check, or full-data check may be used.

When the CRC is used, a CRC of image data displayed is calculated and whether the image data is a still image is determined using the CRC. Using CRC, errors may be made in the determination of whether the image data is that of the still image and the operating speed of the application processor for other tasks may be affected by the CRC calculation.

When the frame buffer address check is used, whether the image data is a still image is determined depending on whether a frame buffer of the application processor is performing a write operation. To use the frame buffer address check, a frame buffer address check function needs to be added to a chip of the application processor during manufacturing.

When the full-data check is used, image data displayed is compared pixel by pixel to determine whether the image data is a still image. At this time, the determination can be performed very accurately, but a lot of memory accesses are necessary and a full-data check function needs to be added during manufacturing.

For the aforementioned reasons, conventional methods of determining whether image data displayed is a still image using the application processor affect the operating speed of the application processor or can be used only when the application processor supports the PSR function.

Further, in the PSR mode, the display driver may control a frame rate of the image data independently from the application processor. Accordingly, in conventional methods that use the application processor to determine whether image data is a still image, when the PSR mode ends, a tearing effect or frame loss may occur in an image since the display driver and the application processor are not synchronized with each other.

### SUMMARY

According to some embodiments of the inventive concepts, there is provided a method of operating a display driver. The method includes comparing cyclic redundancy checks (CRCs) of first frames consecutively received from a data stream; comparing second frames consecutively received from the data stream, with each other, if the first frames have CRCs that are equal to each other; and entering a panel self-refresh mode, if the second frames are equal to each other.

The method may further include transmitting a frame data transmission stop request signal to an application processor if the plurality of second frames are equal to each other. The method may further include transmitting one of the first frames and second frames to a display, if the display driver is operating in the panel self-refresh mode.

The plurality of second frame data may be consecutively follow the first frames in the data stream.

When a plurality of third frame data are received in the panel self-refresh mode, the method may further include adjusting a frame rate of third frames and transmitting the third frames consecutively to a display at an adjusted frame rate, if the third frames are received in the panel self-refresh mode, the third frames following the second frames in the data stream and the third frames representing a different image than the second frames.

The method may further include entering a video mode if the data stream received from the application processor is synchronized with frame data transmitted to the display and the third frames representing the different image received.

According to other embodiments of the inventive concepts, there is provided a display control system including an application processor and a display driver configured to receive a data stream from the application processor, perform cyclic redundancy checks on first frames of the data stream, compare the first frames of the data stream with second frames of the data stream, if the CRCs of the first frames are equal, and enter a panel self-refresh mode if the second frames are equal to each other.

The display driver may transmit a frame data transmission stop request signal to the application processor if the second frames are equal to each other, and the application processor may stop transmitting the data stream in response to the frame data transmission stop request signal.

The display driver may transmit one of the first frames and the second frames to a display, if the display is in the panel self-refresh mode.

The display driver may adjust a frame rate of third frames and transmit the third frames to a display at an adjusted frame rate, if the application processor transmits the third frames in the panel self-refresh mode, the third frames following the second frames in the data stream and the third frames representing a different image than the second frames.

The display driver may enter a video mode if the data stream received from the application processor is synchronized with frame data transmitted to the display at the adjusted frame rate and the third frames representing the different images are transmitted by the application processor.

The display driver may directly transmit frame data received from the application processor to the display, if the display driver has entered the video mode.

According to further embodiments of the inventive concepts, there is provided a method of operating a display driver. The method includes receiving, in a panel self-refresh mode, first frame data from an application processor; determining if the first frame data is synchronized with second frame data transmitted to a display; and adjusting a frame rate of the first frame data and transmitting the first frame data at an adjusted frame rate if the determining determines that the first frame data is not synchronized with the second frame data and entering a video mode if the determining determines that the first frame data is synchronized with the second frame data.

The method may further transmit new frame data received from the application processor directly to the display, if the display driver has entered the video mode. The determining if the first frame data is synchronized with the second frame data is determined according to whether a first vertical blanking interval of the first frame data overlaps with a second vertical blanking interval of the second frame data.

According to another example embodiment, there is provided a method of driving a display device. The method including performing cyclic redundancy checks (CRCs) between a number of frames consecutively received in a data stream; analyzing if the frames contain a same image, if the CRCs of each of the frames are equal; buffering one of the frames containing the same image as a stored frame and transmitting a signal to an application processor, if the analyzing determines that the frames contain the same image, the signal directing the application processor to stop sending the data stream; and transmitting the stored frame to a display device.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a display control system according to some embodiments of the inventive concepts;

FIG. 2 is a block diagram of a panel self-refresh (PSR) controller illustrated in FIG. 1;

FIG. 3 is a flowchart of a method of operating a display driver illustrated in FIG. 1 according to some embodiments of the inventive concepts;

FIG. 4 is a table for explaining the method illustrated in FIG. 3;

FIG. 5 is a flowchart of a method of operating a display driver illustrated in FIG. 1 according to other embodiments of the inventive concepts;

FIG. 6 is a table for explaining the method illustrated in FIG. 5;

FIG. 7 is a block diagram of a display control system according to other embodiments of the inventive concepts;

FIG. 8 is a block diagram of a PSR controller illustrated in FIG. 7;

FIG. 9 is a flowchart of a method of operating a display driver illustrated in FIG. 7 according to some embodiments of the inventive concepts; and

FIG. 10 is a conceptual diagram for explaining the method illustrated in FIG. 9.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

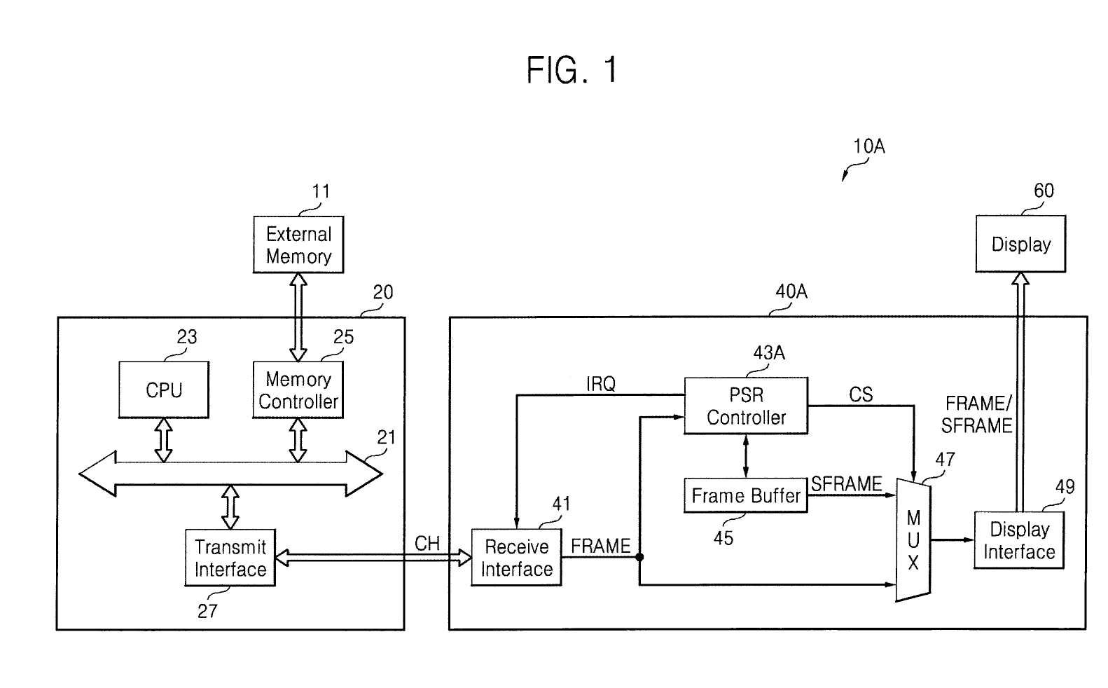

FIG. 1 is a block diagram of a display control system 10A according to some embodiments of the inventive concepts. The display control system 10A includes an external memory 11, an application processor 20, a display driver 40A, and a display 60.

Display control systems 10A and 10B that will be described with reference to FIGS. 1 through 8 may be implemented as a television (TV), a digital TV, an Internet protocol TV (IPTV), a computer, or a portable device.

The portable device may include a two-dimensional (2D) or three-dimensional (3D) display 60. It may be implemented as a handheld device such as a laptop computer, a mobile phone, a smart phone, a tablet personal computer (PC), a personal digital assistant (PDA), an enterprise digital assistant (EDA), a digital still camera, a digital video camera, a portable multimedia player (PMP), a personal navigation device or portable navigation device (PND), a handheld game console, or an e-book.

The external memory 11 may be implemented by a volatile memory such as dynamic random access memory (DRAM) or a non-volatile memory such as a flash memory, a resistive memory, or a phase-change random access memory (PRAM).

The application processor 20 may transmit a frame data FRAME to the display driver 40A through a channel CH. The application processor 20 may include a central processing unit 23, a memory controller 25, and a transmit interface 27, which may communicated with one another through a bus 21.

The CPU 23 controls the overall operation of the application processor 20. For instance, the CPU 23 may control the memory controller 25 and the transmit interface 27.

The memory controller 25 may transmit image data, e.g., moving image data or still image data, output from the external memory 11 to the transmit interface 27 through the bus 21.

The transmit interface 27 transmit the frame data FRAME to the display driver 40A through the channel CH. The transmit interface 27 may transmit various signals to the display driver 40A through the channel CH. In other embodiments, the transmit interface 27 may receive various signals, e.g., a frame data transmission stop request signal IRQ, from the display driver 40A through the channel CH.

The transmit interface 27 may be implemented as a CPU interface, an RGB interface, or a serial interface. It may also be implemented by a mobile display digital interface (MDDI), a mobile industry processor interface (MIPI®), a serial peripheral interface (SPI), an inter-integrated circuit (12C) interface, an interface supporting a displayport (DP), an interface supporting an embedded DP (eDP), or a high-definition multimedia interface (HDMI).

The display driver 40A analyzes a plurality of frame data consecutively output from the application processor 20, determines whether an image corresponding to the plurality of frame data is a still image based on an analysis result, and enters a panel self-refresh (PSR) mode when the image is determined as the still image.

The PSR mode refers to a mode in which the display driver 40A stores a frame data corresponding to a still image and then transmits the frame data to the display 60. In contrast to the PSR mode, a video mode refers to a mode in which the display driver 40A directly output the frame data FRAME received from the application processor 20 to the display 60.

The display driver 40A may adjust a frame rate of the frame data FRAME transmitted to the display 60. For instance, the display driver 40A may decrease the frame rate of the frame data FRAME transmitted to the display 60 within a range avoiding flickering.

The application processor 20 may stop outputting the frame data FRAME in the PSR mode. For instance, the application processor 20 may stop outputting the frame data FRAME in response to the frame data transmission stop request signal IRQ received from the display driver 40A.

The display driver 40A may include a receive interface 41, a PSR controller 43A, a frame buffer 45, a multiplexer (MUX) 47, and a display interface 49.

The receive interface 41 receives the frame data FRAME from the application processor 20 through the channel CH. The receive interface 41 may receive various signals from the application processor 20 through the channel CH. In other embodiments, the receive interface 41 may transmit various signals, e.g., the frame data transmission stop request signal IRQ, to the application processor 20 through the channel CH. The receive interface 41 may be implemented by the same interface as the transmit interface 27.

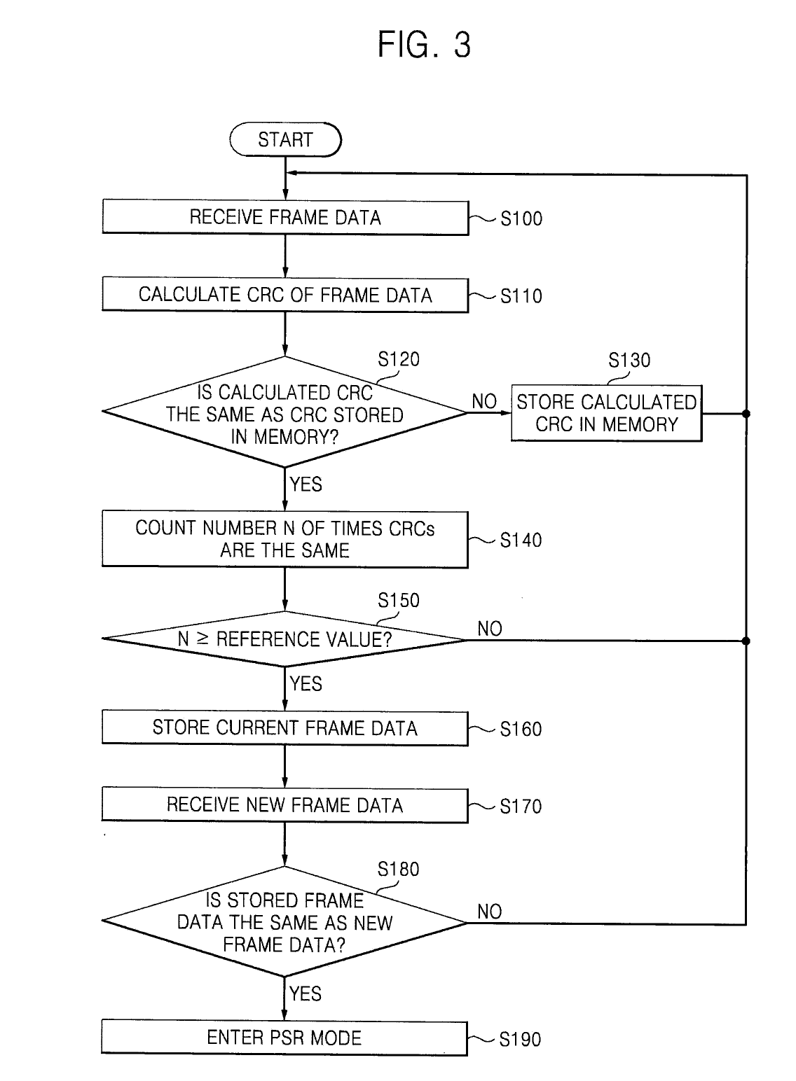

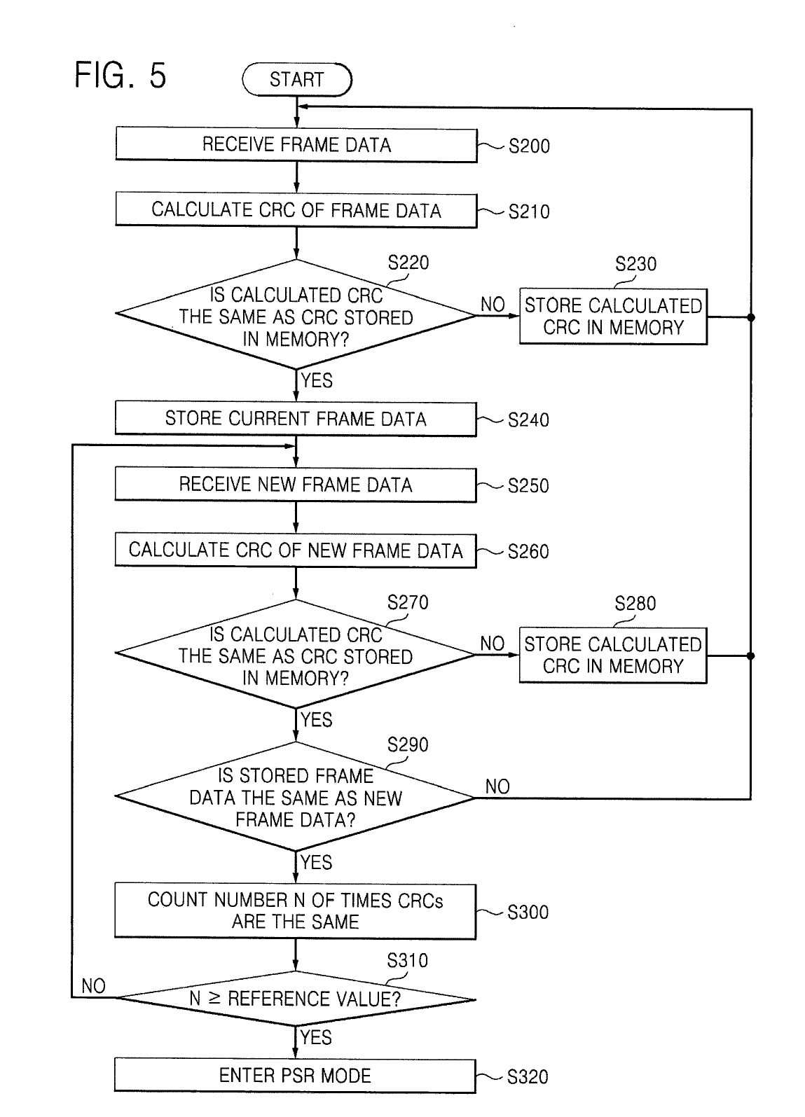

The PSR controller 43A receives a plurality of frame data from the application processor 20 through the receive interface 41, analyzes the frame data, and enters the PSR mode when an image corresponding to the plurality of frame data is determined as a still image. How the PSR controller 43A may determine whether the image corresponding to the plurality of frame data is a still image will be described with reference to FIG. 3 or 5 in detail.

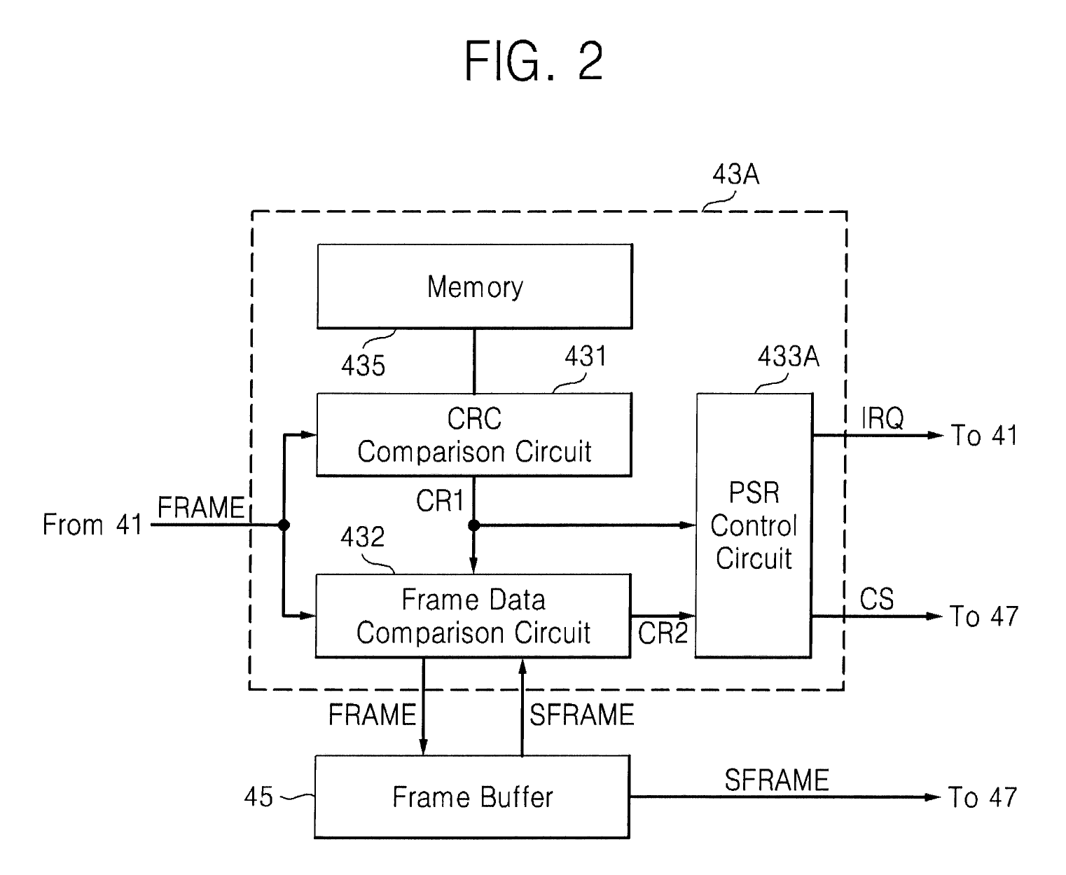

FIG. 2 is a block diagram of the PSR controller 43A illustrated in FIG. 1. The PSR controller 43A includes a cyclic redundancy check (CRC) comparison circuit 431, a frame data comparison circuit 432, a PSR control circuit 433A, and a memory 435. For convenience' sake in the description, the frame buffer 45 is also illustrated in FIG. 2.

The CRC comparison circuit 431 calculates a CRC of each of the plurality of frame data, e.g., first frame data, consecutively received from the application processor 20 through the receive interface 41 and compares the CRCs with each other. In detail, the CRC comparison circuit 431 calculates a CRC of one of the plurality of frame data and stores the calculated CRC in the memory 435. Thereafter, the CRC comparison circuit 431 calculates another frame data consecutively received following the one of the plurality of frame data and compares the calculated CRC of the current frame data with the CRC stored in the memory 435 (i.e., the CRC of the previous frame data).

When there are the plurality of first frame data having the same CRC, the CRC comparison circuit 431 may output the CRC comparison result signal CR1 to the frame data comparison circuit 432 and the PSR control circuit 433A. Alternatively, when the number of the plurality of first frame data whose CRCs are the same is at least a reference value, the CRC comparison circuit 431 may output the CRC comparison result signal CR1 to the frame data comparison circuit 432 and the PSR control circuit 433A.

The frame data comparison circuit 432 compares the first frame data with a plurality of second frame data consecutively received following the first frame data in response to the CRC comparison result signal CR1 output from the CRC comparison circuit 431. By performing the frame data comparison only when the CRC comparison indicates that the CRCs are the same, the amount of memory accesses may be reduced.

In detail, the frame data comparison circuit 432 stores the first frame data FRAME in the frame buffer 45. The frame data comparison circuit 432 reads a stored frame data SFRAME from the frame buffer 45 and compares it with a second frame data FRAME.

The frame data comparison circuit 432 may output the frame data comparison result signal CR2 to the PSR control circuit 433A when the stored frame data SFRAME is determined to be the same as the second frame data. Alternatively, the frame data comparison circuit 432 may output the frame data comparison result signal CR2 to the PSR control circuit 433A when the number of the plurality of second frame data FRAME that are determined to be the same as the stored frame data SFRAME is at least a reference value. By using the frame data comparison, errors that may arise in the CRC comparison's determination that the image data is that of a still image may be reduced.

The PSR control circuit 433A converts the operation mode of the PSR controller 43A from the video mode to the PSR mode in response to the CRC comparison result signal CR1 output from the CRC comparison circuit 431 and the frame data comparison result signal CR2 output from the frame data comparison circuit 432 and outputs the control signal CS to a selection input of the MUX 47.

The control signal CS is a signal for controlling the MUX 47 to output the frame data FRAME output from the receive interface 41 in the video mode and to output the stored frame data SFRAME output from the frame buffer 45 in the PSR mode.

The PSR control circuit 433A may output the frame data transmission stop request signal IRQ to the receive interface 41 when the video mode is converted into the PSR mode. The receive interface 41 may transmit the frame data transmission stop request signal IRQ output from the PSR control circuit 433A to the application processor 20 through the channel CH. The application processor 20 may stop outputting a frame data in response to the frame data transmission stop request signal IRQ.

The frame buffer 45 stores the frame data FRAME received from the PSR controller 43A and outputs the stored frame data SFRAME to the PSR controller 43A and the MUX 47.

The MUX 47 outputs the frame data FRAME received from the receive interface 41 or the stored frame data SFRAME received from the frame buffer 45 to the display interface 49 in response to the control signal CS received from the PSR controller 43A.

The display interface 49 transmits the frame data FRAME or the stored frame data SFRAME from the MUX 47 to the display 60. The display 60 displays the frame data FRAME bypassing the frame buffer 45 in the video mode and displays the stored frame data SFRAME output from the frame buffer 45 in the PSR mode. By stopping transmission of the frame data and displaying the stored frame data SFRAME, power consumption may be reduced.

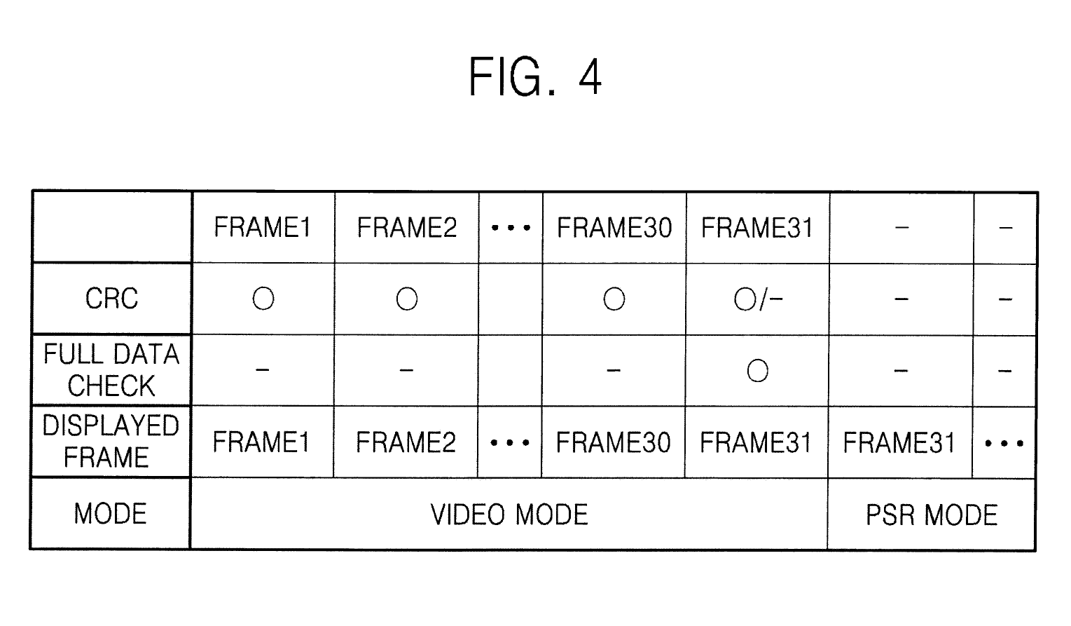

FIG. 3 is a flowchart of a method of operating the display driver 40A illustrated in FIG. 1 according to some embodiments of the inventive concepts. FIG. 4 is a table to further explain the method illustrated in FIG. 3.

Referring to FIGS. 1 through 4, the display driver 40A receives a frame data from the application processor 20 in operation 5100 and calculates a CRC of the frame data in operation 5110.

The display driver 40A compares the calculated CRC with a CRC stored in the memory 435 in operation 5120. When the CRCs are not the same, the display driver 40A stores the calculated CRC in the memory 435 in operation 5130. However, when the CRCs are the same, the display driver 40A counts the number N of times the CRCs are the same in operation S140. Operations S110 through S140 may be performed by the CRC comparison circuit 431 in the display driver 40A.

The display driver 40A repeats the operations S100-S140 for other frame data. When the counted number N is at least a reference (or, alternatively a threshold) value in operation S150, the display driver 40A stores the current frame data in the frame buffer 45 in operation S160 and receives a new frame data in operation S170.

The display driver 40A compares the frame data stored in the frame buffer 45 with the new frame data in operation S180. When it is determined that the frame data stored in the frame buffer 45 is the same as the new frame data as a result of the comparison, the display driver 40A determines an image corresponding to a plurality of consecutive frame data as a still image and enters the PSR mode in operation S190. Operations S160 through S180 may be performed by the frame data comparison circuit 432 in the display driver 40A. Operation S190 may be performed by the PSR control circuit 433A in the display driver 40A.

Each of the stored frame data and the new frame data may include image data and a CRC corresponding to the image data.

For instance, when the reference value is 30, the display driver 40A may receive displayed frames FRAME1 to FRAME31 as shown in FIG. 4, the display driver 40A compares CRCs of respective first through thirtieth frame data FRAME1 through FRAME30, which are consecutively received. When the CRCs of the respective frame data FRAME1 through FRAME30 are all the same, the display driver 40A compares the plurality of frame data FRAME1 through FRAME30 with a thirty-first frame data FRAME31. When the plurality of frame data FRAME1 through FRAME30 are the same as the thirty-first frame data FRAME31, the display driver 40A changes from the video mode into the PSR mode.

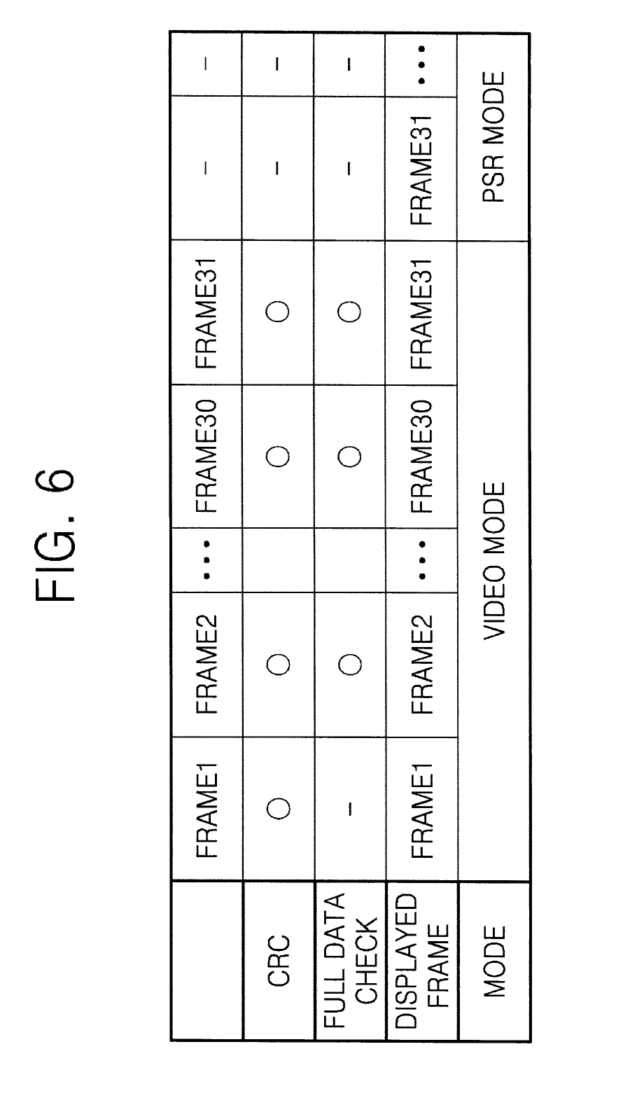

FIG. 5 is a flowchart of a method of operating the display driver 40A illustrated in FIG. 1 according to other embodiments of the inventive concepts. FIG. 6 is a table for further explaining the method illustrated in FIG. 5.

Referring to FIGS. 1, 2, 5, and 6, the display driver 40A receives a frame data from the application processor 20 in operation 5200 and calculates a CRC of the frame data in operation 5210.

The display driver 40A compares the calculated CRC with a CRC stored in the memory 435 in operation 5220. When the CRCs are not the same, the display driver 40A stores the calculated CRC in the memory 435 in operation 5230. However, when the CRCs are the same, the display driver 40A stores the current frame data in the frame buffer 45 in operation S240.

The display driver 40A receives a new frame data from the application processor 20 in operation 5250, calculates a CRC of the new frame data in operation 5260, and compares the calculated CRC with the CRC stored in the memory 435 in operation 5270.

When the CRCs are not the same in operation 5270, the display driver 40A stores the calculated CRC in the memory 435 in operation S280.

However, when the CRCs are the same in operation S270, the display driver 40A compares the new frame data with the frame data stored in the memory buffer 45 in operation S290. When it is determined that the new frame data is the same as the frame data stored in the memory buffer 45 as a result of the comparison, the display driver 40A counts the number N of times the CRCs are the same in operation 5300 and compares the counted number N with a reference (or, alternatively a threshold) value S310.

The display driver 40A repeats operations 5250 through 5300 until the counted number N is at least the reference value. When the counted number N is at least the reference value, the display driver 40A changes from the video mode into the PSR mode in operation S320. Operations 5210 through S230 and 5260 through 5280 may be performed by the CRC comparison circuit 431 in the display driver 40A. Operations 5240 and 5290 through 5310 may be performed by the frame data comparison circuit 432 and operation S320 may be performed by the PSR control circuit 433A in the display driver 40A. Therefore, in the method illustrated in FIG. 5, the frame data of the first two frames, FRAME1 and FRAME2 are each compared with frame data of the other frames up to the reference or threshold value, unlike the method illustrated in FIG. 3, where the frame data for the plurality of frames up to the reference or threshold value is compared only with the last frame. This difference is illustrated in a comparison of the full data check row of FIG. 4 with the full data check row of FIG. 6.

For instance, when the reference value is 30, the display driver 40A may receive the displayed frames FRAME1 to FRAME31 as shown in FIG. 6, and the display driver 40A compares CRCs of respective first and second frame data FRAME1 and FRAME2, which are consecutively received. When the CRCs of the respective frame data FRAME1 and FRAME2 are the same, the display driver 40A compares the frame data FRAME1 and FRAME2 with third through thirty-first frame data FRAME3 through FRAME31. When the frame data FRAME1 and FRAME2 are the same as the third through thirty-first frame data FRAME3 through FRAME31, the display driver 40A changes from the video mode into the PSR mode.

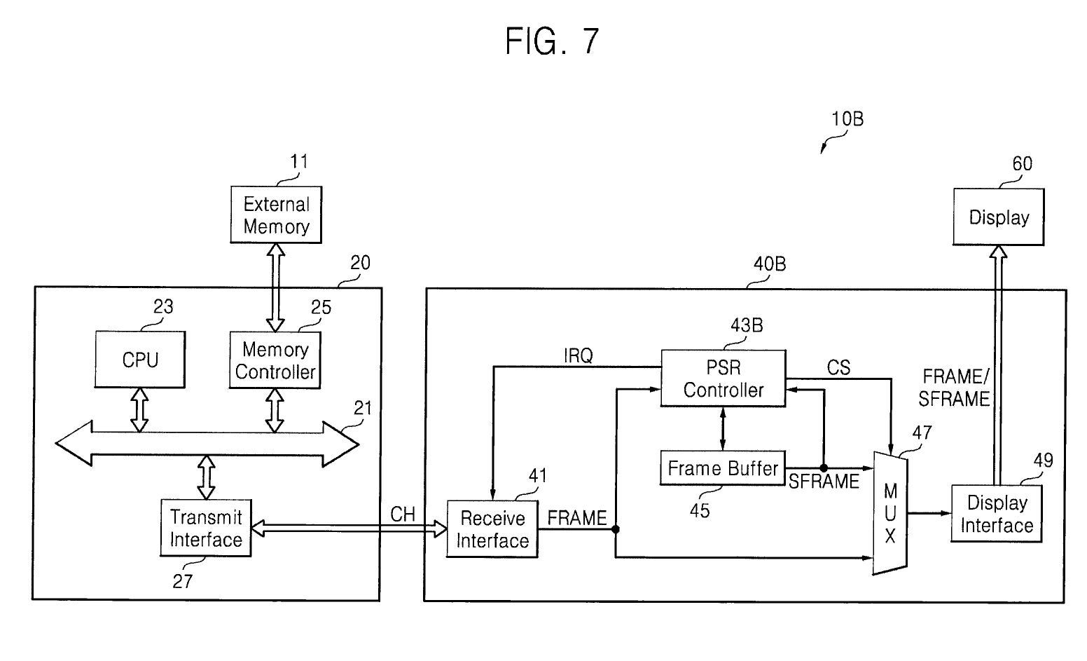

FIG. 7 is a block diagram of a display control system 10B according to other embodiments of the inventive concepts. The display control system 10B includes the external memory 11, the application processor 20, a display driver 40B, and the display 60.

The functions and the operations of the external memory 11, the application processor 20, and the display 60 illustrated in FIG. 7 are the same as those of the external memory 11, the application processor 20, and the display 60 illustrated in FIG. 1. Thus, descriptions thereof will be omitted.

The display driver 40B changes from the PSR mode into an intermediate mode in response to frame data output from the application processor 20 indicating the frame data no longer represents a still image.

When the application processor 20 has stopped outputting frame data in response to the frame data transmission stop request signal IRQ received from the display driver 40B, the display driver 40B may change from the PSR mode into the intermediate mode in response to new frame data received from the application processor 20.

Alternatively, when the application processor 20 continuously outputs frame data even though it receives the frame data transmission stop request signal IRQ from the display driver 40B, for instance, when the application processor 20 does not support the PSR mode, the display driver 40B may compare CRCs of respective frame data, which are consecutively received from the application processor 20, with each other and may change from the PSR mode into the intermediate mode when the CRCs are different from each other.

The intermediate mode refers to a mode in which the display driver 40B stores frame data received from the application processor 20, adjusts the frame rate of the frame data, and transmits the rate-adjusted frame data to the display 60.

The display driver 40B determines whether frame data received from the application processor 20 is synchronized with frame data transmitted to the display 60 according to whether a vertical blanking interval (VBI) between frame data consecutively received from the application processor 20 overlaps with a VBI between frame data consecutively transmitted to the display 60.

The display driver 40B may include the receive interface 41, a PSR controller 43B, the frame buffer 45, the MUX 47, and the display interface 49. The functions and the operations of the receive interface 41, the frame buffer 45, the MUX 47, and the display interface 49 illustrated in FIG. 7 are the same as those of the receive interface 41, the frame buffer 45, the MUX 47, and the display interface 49 illustrated in FIG. 1. Thus, descriptions thereof will be omitted.

The PSR controller 43B determines whether there is synchronization or non-synchronization between frame data FRAME received from the application processor 20 through the receive interface 41 and frame data SFRAME output from the frame buffer 45 to the MUX 47 according to whether a first VBI of the frame data FRAME received from the application processor 20 overlaps with a second VBI of the frame data SFRAME output from the frame buffer 45 to the MUX 47.

When the frame data FRAME received from the application processor 20 is not synchronized with the frame data SFRAME output from the frame buffer 45 to the MUX 47, the PSR controller 43B adjusts the frame rate of the frame data SFRAME. Alternatively, when the frame data FRAME received from the application processor 20 is synchronized with the frame data SFRAME output from the frame buffer 45 to the MUX 47, the PSR controller 43B changes from the intermediate mode into the video mode.

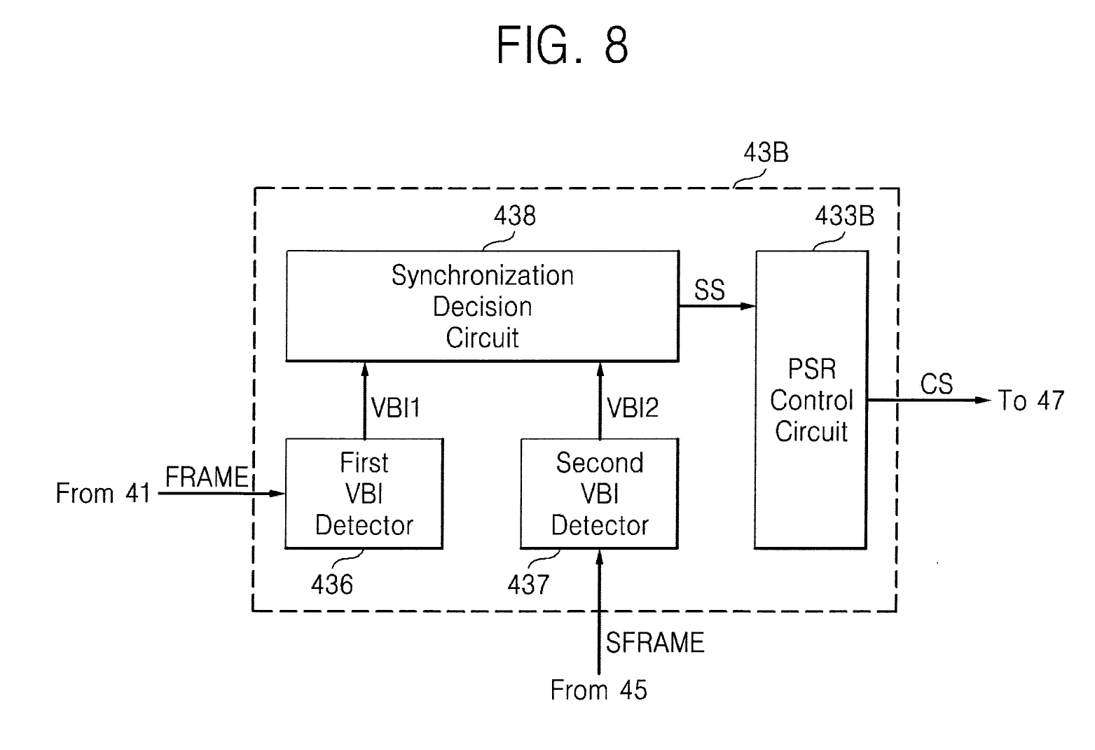

FIG. 8 is a block diagram of the PSR controller 43B illustrated in FIG. 7. Referring to FIGS. 7 and 8, the PSR controller 43B includes a first VBI detector 436, a second VBI detector 437, a synchronization decision circuit 438, and a PSR control circuit 433B.

The first VBI detector 436 detects the VBI of the frame data FRAME received through the receive interface 41 from the application processor 20 and outputs a first VBI signal VBI1 indicating the VBI to the synchronization decision circuit 438. The second VBI detector 437 detects the VBI of the frame data SFRAME output from the frame buffer 45 and outputs a second VBI signal VBI2 indicating the VBI to the synchronization decision circuit 438.

In other words, the first and second VBI detectors 436 and 437 may detect a VBI between consecutive frame data. In other embodiments, the display driver 40B may detect a VBI between frame data consecutively received from the application processor 20 according to whether a data enable signal output from the application processor 20 together with the frame data is received.

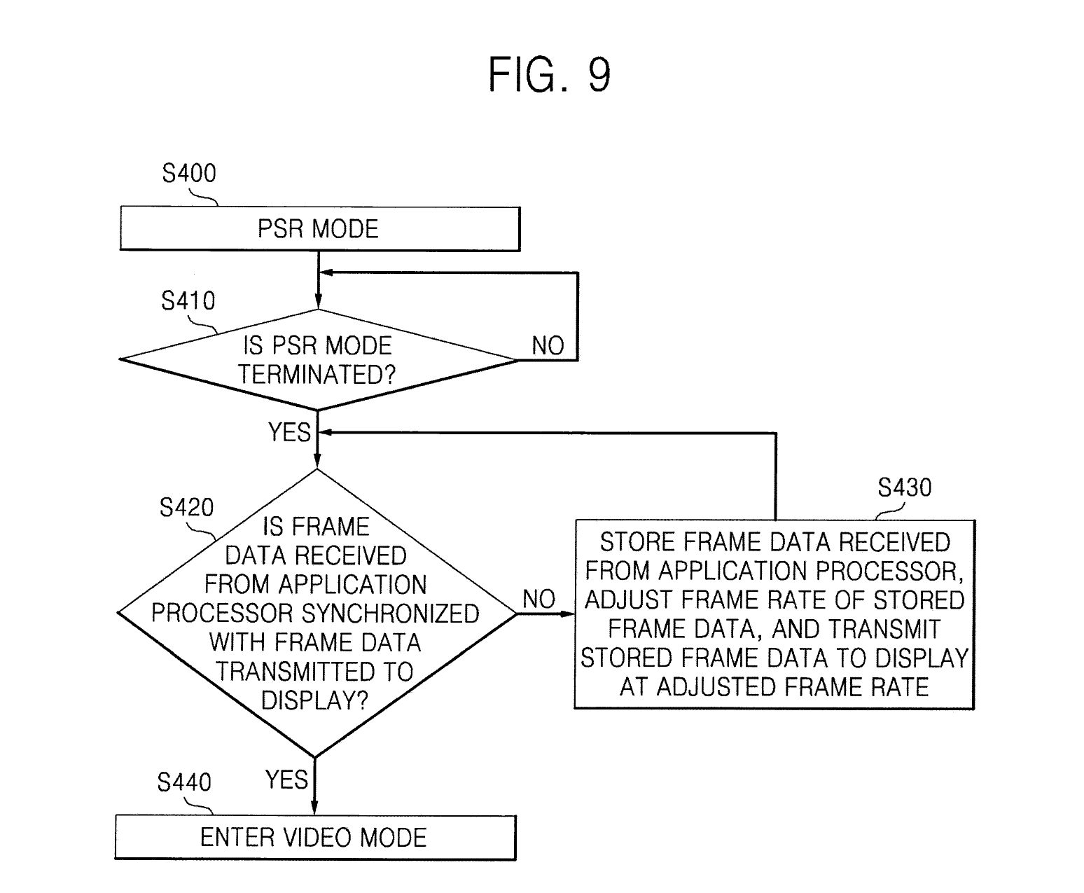

The synchronization decision circuit 438 receives the first VBI signal VBI1 from the first VBI detector 436 and the second VBI signal VBI2 from the second VBI detector 437 and outputs a synchronization signal SS to the PSR control circuit 433B when both of the first and second VBI signals VBI1 and VBI2 indicate a same VBI. In other words, the synchronization decision circuit 438 outputs the synchronization signal SS to the PSR control circuit 433B when the frame data FRAME received through the receive interface 41 from the application processor 20 is synchronized with the frame data SFRAME output from the frame buffer 45 to the MUX 47. When the frame data FRAME is not synchronized with the frame data SFRAME, the display driver 40B may adjust the frame rate as described below with reference to FIG. 9 such that the frame rate becomes synchronized.

The PSR control circuit 433B outputs the control signal CS to the MUX 47 in response to the synchronization signal SS received from the synchronization decision circuit 438 to control the frame data FRAME received through the receive interface 41 from the application processor 20 to be output to the display 60.

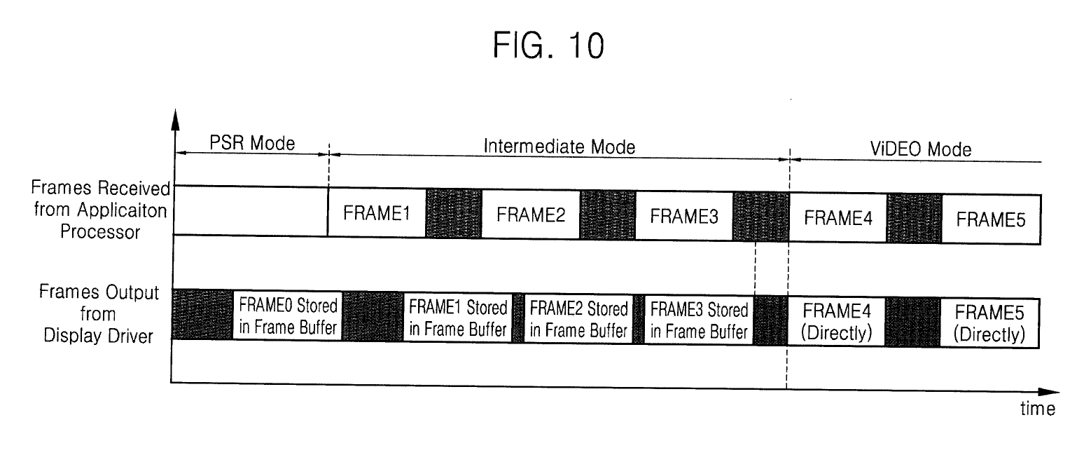

FIG. 9 is a flowchart of a method of operating the display driver 40B illustrated in FIG. 7 according to some embodiments of the inventive concepts. FIG. 10 is a conceptual diagram for further explaining the method illustrated in FIG. 9.

Referring to FIGS. 7 through 9, the display driver 40B outputs the frame data SFRAME stored in the frame buffer 45 in the PSR mode. In the PSR mode, the display driver 40B may adjust the frame rate of the frame data SFRAME within a range avoiding flickering and output the frame data SFRAME to the display 60 at the adjusted rate in operation S400 in order to reduce power consumption.

The display driver 40B determines whether to terminate the PSR mode in operation S410. The display driver 40B may change from the PSR mode into the intermediate mode in response to new frame data received from the application processor 20.

In the intermediate mode, the display driver 40B determines whether the frame data FRAME received from the application processor 20 is synchronized with the frame data SFRAME transmitted to the display 60 in operation S420.

When it is determined that the frame data FRAME received from the application processor 20 is not synchronized with the frame data SFRAME transmitted to the display 60, the display driver 40B stores the frame data FRAME received from the application processor 20 in the frame buffer 45, adjusts the frame rate of the stored frame data SFRAME, and transmits the stored frame data SFRAME to the display 60 at the adjusted frame rate in operation 5430. At this time, the PSR controller 43B of the display driver 40B may adjust the frame rate by decreasing the VBI of the stored frame data SFRAME output from the frame buffer 45 to the MUX 47.

When it is determined that the frame data FRAME received from the application processor 20 is synchronized with the frame data SFRAME transmitted to the display 60, the display driver 40B changes from the intermediate mode into the video mode in operation S440.

For instance, as shown in FIG. 10, the display driver 40B outputs a frame data FRAME0 stored in the frame buffer 45 to the display 60 in the PSR mode. When a new frame data FRAME1 is received from the application processor 20, the display driver 40B change from the PSR mode into the intermediate mode.

While frame data received from the application processor 20 is not synchronized with frame data output to the display 60 (e.g., while frame data FRAME1 through FRAME3 are being output), the display driver 40B may adjust the frame rate of the frame data output to the display 60, e.g., by reducing the VBI of the stored frame data SFRAME output from the frame buffer 45 thus synchronizing the frame data received from the application processor 20 with the frame data output to the display 60.

When the frame data received from the application processor 20 is synchronized with the frame data output to the display 60, the display driver 40B changes from the intermediate mode into the video mode. In the video mode, the display driver 40B directly outputs frame data (e.g., FRAME4 and FRAME5) received from the application processor 20 to the display 60.

As described above, according to some embodiments of the inventive concepts, a display driver determines whether an image is a still image and prevents a tearing effect or frame loss when a PSR mode ends.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of operating a display driver, the method comprising:
comparing cyclic redundancy checks (CRCs) of first frames consecutively received from a data stream, with each other;
comparing second frames consecutively received from the data stream, with each other, if the first frames have CRCs that are equal to each other; and
entering a panel self-refresh mode, if the second frames are equal to each other.

2. The method of claim 1, further comprising:
transmitting a frame data transmission stop request signal to an application processor, if the second frames are equal to each other.

3. The method of claim 1, further comprising:
transmitting one of the first frame and the second frame to a display, if the display driver is operating in the panel self-refresh mode.

4. The method of claim 1, wherein the second frames consecutively follow the first frames in the data stream.

5. The method of claim 1, further comprising:
adjusting a frame rate of third frames and transmitting the third frames consecutively to a display at an adjusted frame rate, if the third frames are received in the panel self-refresh mode, the third frames following the second frames in the data stream and the third frames representing a different image than the second frames.

6. The method of claim 5, further comprising:
entering a video mode, if the data stream received from an application processor is synchronized with frame data transmitted to the display and the third frames representing the different image are received.

7.-12. (canceled)

13. A method of operating a display driver, the method comprising:
receiving, in a panel self-refresh mode, first frame data from an application processor;
determining if the first frame data is synchronized with second frame data, the second frame data being data transmitted to a display; and
adjusting a frame rate of the first frame data and transmitting the first frame data at an adjusted frame rate, if the determining determines that the first frame data is not synchronized with the second frame data; and
entering a video mode, if the determining determines that the first frame data is synchronized with the second frame data.

14. The method of claim 13, further comprising:
transmitting new frame data received from the application processor directly to the display, if the display driver has entered the video mode.

15. The method of claim 13, wherein the determining if the first frame data is synchronized with the second frame data is determined according to whether a first vertical blanking interval of the first frame data overlaps with a second vertical blanking interval of the second frame data.

16. A method of driving a display device, the method comprising:
performing cyclic redundancy checks (CRCs) between a number of frames consecutively received in a data stream;
analyzing if the frames contain a same image, if the CRCs of each of the frames are equal;
buffering one of the frames containing the same image as a stored frame and transmitting a signal to an application processor, if the analyzing determines that the frames contain the same image, the signal directing the application processor to stop sending the data stream; and
transmitting the stored frame to a display device.

17. The method of claim 16, wherein analyzing is performed, if the CRCs between a threshold amount of the frames are equal.

18. The method of claim 16, further comprising:
adjusting a frame rate between the stored frame and the frames consecutively received, if the stored frame and the frames consecutively received are not synchronized and the frames consecutively received do not contain the same image as the stored frame;
transmitting the stored frame at an adjusted frame rate to the display device; and
transmitting the data stream directly to the display device, if the frame rate of the stored frame is synchronized with the frames consecutively received in the data stream.

19. The method of claim 18, wherein the stored frame and the frames of the data stream are not synchronized, if a time of a first line of the stored frame does not occur at a same time as a first line of the frames of the data stream.
